(19) United States
(12) Patent Application Publication
(10) Pub. No.: US 2009/0021515 A1
(43) Pub. Date: Jan. 22, 2009

(54) High Performance Ray Tracing Scene Graphs

(75) Inventor: Alexis Naveros, Montreal (CA)

Correspondence Address: PROCOPIO, CORY, HARGREAVES & SAVITCH LLP, 530 B STREET, SUITE 2100, SAN DIEGO, CA, 92101, US

(73) Assignee: Survice Engineering, Inc., Belcamp, MD (US)

(21) Appl. No.: 12/114,633

(22) Filed: May 2, 2008

Related U.S. Application Data
(60) Provisional application No. 60/915,615, filed on May 2, 2007.

(51) Int. Cl. G06T 17/00

(52) U.S. Cl. 345/420

(57) ABSTRACT

Systems and methods for high performance ray tracing scene graphs are provided by constructing a complex three dimensional special structure of sectors and nodes. Sectors are regions of space which can take any shape or size in three dimensional space. The non tree-based space partitioning structure allows rays to traverse the spatial structure to directly resolve the primitives they intersect. Traversal cost is efficiently minimized by constructing large sectors to contain empty space and constructing relatively smaller sectors to contain the geometric primitives. Each sector contains information associated with each of its surfaces including whether the surface leads to another sector or a node.

### RELATED APPLICATION

The present application claims priority to U.S. provisional patent application Ser. No. 60/915,615 filed May 2, 2007, which is incorporated herein by reference in its entirety.

### BACKGROUND

1. Field of the Invention

The present invention generally relates to computer graphics and more specifically relates to high performance ray tracing.

2. Related Art

Conventional ray tracing is used to generate images by tracing the path of light through pixels in an image plane. Ray tracing advantageously produces a very high degree of photorealism but suffers from significant computational cost. This makes ray tracing best suited for applications where the image can be rendered slowly ahead of time, such as in still images and film and television special effects, and more poorly suited for real-time applications like computer games where speed is critical. Ray tracing is capable of simulating a wide variety of optical effects, such as reflection and refraction, scattering, and chromatic aberration.

Typically, conventional ray tracing employs a variety of space partitioning techniques to reduce the computational costs of resolving the intersection points of rays with a set of given geometry. The conventional techniques require creation of an acceleration data structure that is in the form of a hierarchical tree. These hierarchical tree-based acceleration data structures are created using Binary Space Partitioning, K-Dimensional Trees, and Bounding Volume Hierarchies.

A significant disadvantage of these conventional ray tracing techniques is that they require traversing a tree of some sort from the root (top) node for each ray. Recently, various attempts have been made to initiate the tracing of rays from starting points within the hierarchical structures (i.e., not starting at the root node), and traverse only specific branches of the whole trees to reduce computational cost. Even with this incremental improvement, the acceleration data structures remain hierarchical trees that suffer from the inability to efficiently exploit the locality of rays.

Additionally, in conventional ray tracing, resolving the intersection points of rays with triangulated geometry requires the use of intersection tests such as Moller-Trumbore which are sub-optimal and therefore unnecessarily increase computational costs. Furthermore, in conventional ray tracing, the tree-based hierarchical acceleration data structures are typically built with pointers to access the child nodes of any given node. These pointer intensive data structures consume a significant amount of memory and therefore place burdensome demands on the cache memory of processors, which in turn negatively impacts performance and increases computational costs.

Therefore, what is needed is a system and method that overcomes these significant problems found in the conventional systems as described above.

### SUMMARY

Described herein are systems and methods for using high performance ray tracing scene graphs in ray tracing applications. The task of tracing rays intersecting geometric primitives is used in many industries. Certain tasks, such as photo-realistic rendering or engineering analyses require vast amounts of rays to be traced through virtual three-dimensional worlds. The systems and methods described herein provide a novel space partitioning structure to greatly accelerate the task of resolving the intersection point of rays with geometric primitives. Both the locality and coherency of rays are also efficiently exploited to enhance performance. The locality of a ray is efficiently exploited by finding the intersection point of a ray with the geometry of a scene while minimizing the computational cost of the geometry lying outside of the path of the ray. Advantageously, efficiently exploiting the locality of rays results in a significant performance improvement because geometry outside of the path of the ray does not negatively affect performance.

In one embodiment, high performance ray tracing scene graphs are provided by constructing a complex three dimensional spatial structure of sectors and nodes. Sectors are regions of space which can take any shape or size in three dimensional space. The three dimensional space partitioning structure allows rays to traverse the spatial structure to directly resolve the geometric primitives they intersect. Traversal cost is efficiently minimized by constructing large sectors that contain empty space and constructing relatively smaller sectors that contain the geometric primitives. Each sector contains information associated with each of its surfaces and whether the surface leads to another sector or a node.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a flow diagram illustrating an example process for creating a three dimensional space partitioning structure according to an embodiment of the invention;

FIG. 2 is a block diagram illustrating an example sector in a three dimensional space partitioning structure according to an embodiment of the invention;

FIG. 3 is a block diagram illustrating two example sectors connected by a node in a three dimensional space partitioning structure according to an embodiment of the invention;

FIG. 4 is a block diagram illustrating an example three dimensional space partitioning structure with a plurality of sectors according to an embodiment of the invention;

FIG. 5 is a block diagram illustrating an example three dimensional space partitioning structure with a plurality of sectors shown in graph form according to an embodiment of the invention;

FIG. 6 is a flow diagram illustrating an example process for tracing a ray through a three dimensional space partitioning structure according to an embodiment of the invention; and

FIG. 7 is a block diagram illustrating an example computer system that may be used in connection with various embodiments described herein.

### DETAILED DESCRIPTION

Certain embodiments as disclosed herein provide for using high performance ray tracing scene graphs in ray tracing applications. For example, one method disclosed herein creates a three dimensional spatial structure of sectors and nodes that greatly accelerates the task of resolving the intersection point of rays with geometric primitives in a computer generated scene while minimizing the computational costs related to the geometry outside the path of the ray.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

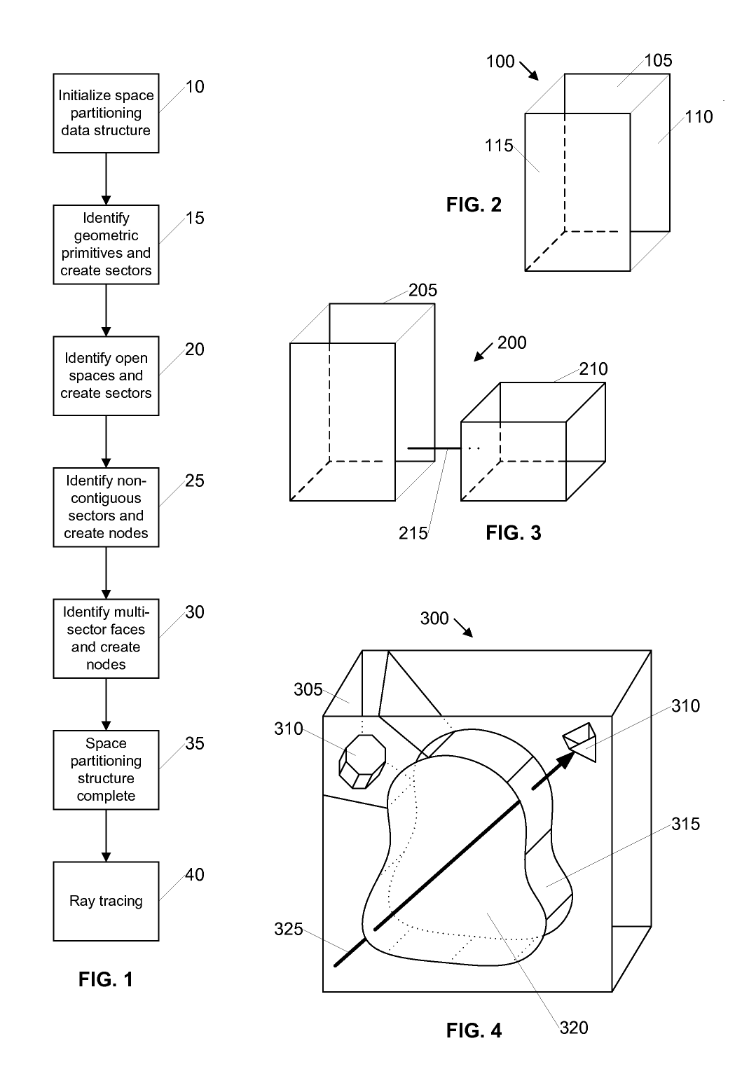

FIG. 1 is a flow diagram illustrating an example process for creating a three dimensional space partitioning structure according to an embodiment of the invention. The process may be carried out by any computer implemented graphical processing device such as the general purpose computer later described with respect to FIG. 7. Initially, in step 10 the space partitioning data structure is initialized, for example by allocating a portion of the memory of a computer and creating the space partitioning data structure in memory. Next, in step 15 geometric primitives in the scene are identified and one or more sectors are created that contain the identified geometric primitives. In one embodiment, the geometric primitives are tightly enclosed in sectors in order to maximize the amount of open space in the three dimensional space partitioning structure. Alternatively, a plurality of geometric primitives may be collected into a single sector. Next, in step 20 open spaces are identified and one or more sectors are created that contain the identified open space.

A sector can take any of a variety of shapes and sizes. In one embodiment sectors are axis-aligned hexahedral spatial regions which can take any shape or size. To minimize traversal cost (in terms of computational time and resources), empty space is advantageously contained in large sectors while many smaller sectors contain the geometric primitives. Each sector contains information (e.g., memory address pointers) associated with each of its surfaces. Each surface of a sector may lead either to another sector or a node to guide the path of a ray.

Next, in steps 25 and 30 non-contiguous sectors (e.g., neighboring sectors that do not have adjacent faces) are identified and nodes are created to guide the path of a ray from the face of one sector to the neighboring sector. Similarly, where a single face of a sector is adjacent (or non-contiguous) to more than one neighboring sector, nodes are created to guide the path of the ray exiting the sector from that face to the appropriate one of the neighboring sectors.

In one embodiment, a node is the traversal of a face of a sector and comprises the result of a test to determine which side of a given axis-aligned plane (e.g., sector face) that the ray will continue its course. Each of the two branches of a node (one on each side of the sector face) may lead to another node or a sector. Because the face of a sector may not lead entirely to a single other such volume of space, nodes act as separation planes, guiding rays towards the next sector to be traversed. To minimize the average traversal cost for all rays, the three dimensional space partitioning structure can be constructed using a converging optimization function. Optimized three dimensional space partitioning structures may also contain overlapping sectors and other shortcuts as part of the acceleration structure.

Once the sectors and nodes have all been created, the three dimensional space partitioning structure is complete, as shown in step 35. This combination of sectors (which may overlap each other) and nodes constitute a complex graph to efficiently guide the path of a ray. Advantageously, the three dimensional space partitioning structure (i.e., the graph) is built by seeking to minimize the computed traversal cost of the whole graph for the sum of all possible rays. After the three dimensional space partitioning structure is complete, ray tracing using the graph may begin, as shown in step 40.

FIG. 2 is a block diagram illustrating an example sector 100 in a three dimensional space partitioning structure according to an embodiment of the invention. In the illustrated embodiment the sector is shown as a rectangular cube structure, although a sector can be of any of a variety of shapes and sizes, including irregular polygons, hexahedrons, and the like. The sector 100 comprises a plurality of planar faces (six in this embodiment), namely top face 105, side face 110, and front face 115. Each of these faces in the space partitioning data structure comprises information (e.g., memory address pointers) that is used to guide the path of a ray.

FIG. 3 is a block diagram illustrating two example sectors 205 and 210 connected by a node 215 in a three dimensional space partitioning structure 200 according to an embodiment of the invention. In the illustrated embodiment, the size of the sectors 205 and 210 are such that a ray traversing the side face of sector 205 may or may not be guided to sector 210. Accordingly, node 215 is employed to assist in guidance of rays that traverse the face of sector 205 and are headed toward sector 210. Not shown is a second node that would guide a ray traversing the face of sector 205 that is headed toward a different sector (or node) other than sector 210.

FIG. 4 is a block diagram illustrating an example three dimensional space partitioning structure 300 with a plurality of sectors 305 and 320 according to an embodiment of the invention. In the illustrated embodiment, the structure 300 comprises a sector 305 that includes a geometric primitive 310. The sector 320 is a large sector that comprises open space and has a number of faces such as face 315. In the illustrated embodiment, the sectors are not regular shaped hexahedrons. However, the sectors could also be such regular shaped hexahedrons in an alternative embodiment, which may result in further savings of computational costs.

Also shown in FIG. 4 is ray 325 that is traversing the three dimensional space partitioning structure 300. As shown, the ray 325 traverses the face of sector 320 that contains open space and the information associated with the face is used to direct the ray 325 toward the appropriate face on the other side of the sector 325, where the ray leaves the sector 325 by traversing that face. As can be seen, the path of the ray, as determined by the information associated with the face from which the ray exited sector 325 continues and intersects with geometric primitive 310 as it traverses the next sector (not shown). As rays linearly traverse the space through the graph, intersection tests are performed for all geometric primitives contained in a sector to determine if the ray intersects any geometric primitive.

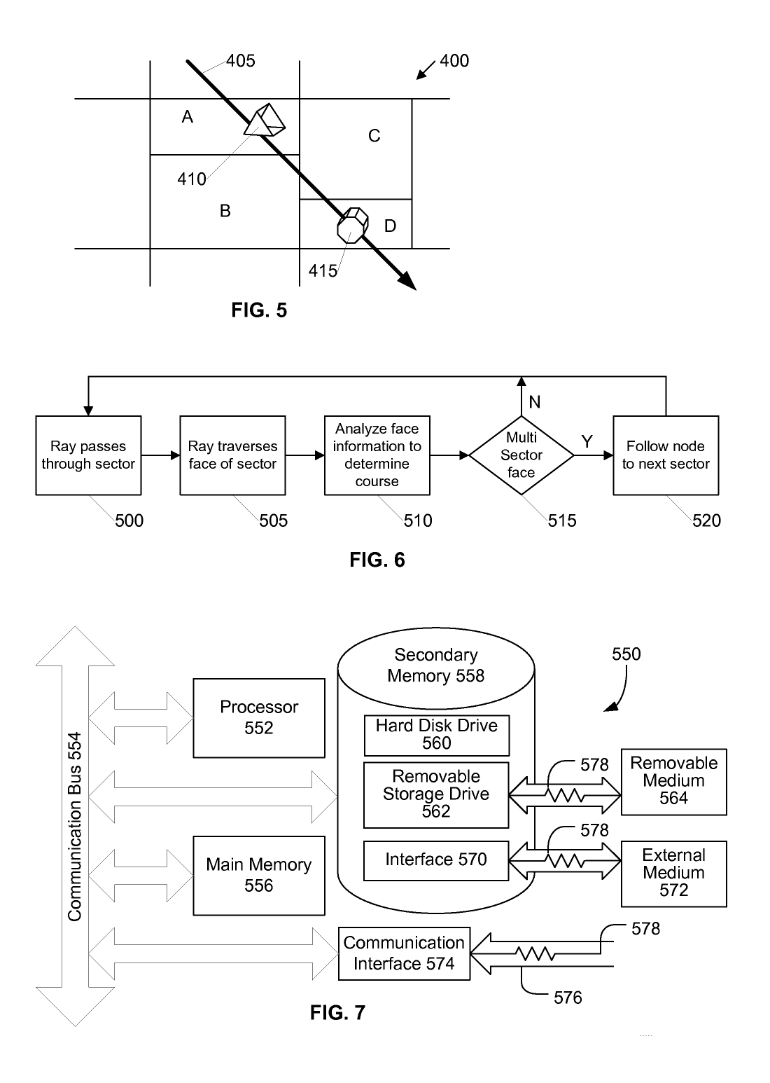

FIG. 5 is a block diagram illustrating an example three dimensional space partitioning structure 400 with a plurality of sectors A, B, C, and D shown in graph form according to an embodiment of the invention. The graph 400 also includes geometric primitives 410 in sector A and 415 in sector D. A ray 405 is shown traversing each of the sectors A, B, C, and D of the graph 400. As the ray 405 traverses the face of sector A, its path through sector A and traversal to sector B is determined. Additionally, intersect tests are performed to determine that the ray 405 intersects with geometric primitive 410. Once the ray 405 traverses into sector B, information from the face of sector B is used to determine the path of the ray 405 through sector B and whether or not the ray 405 will traverse into sector C or sector D. Additionally, because sector B is an open space sector with no geometric primitives, computational costs are saved by not having to perform any intersect tests.

Similarly, as the ray 405 traverses sector C computational costs are preserved and the path of the ray 405 is determined to traverse over into sector D. Intersect tests are performed in sector D to determine that the ray 405 intersects with geometric primitive 415 and then the ray 405 exits the graph 400.

FIG. 6 is a flow diagram illustrating an example process for tracing a ray through a three dimensional space partitioning structure according to an embodiment of the invention. The process may be carried out by any computer implemented graphical processing device such as the general purpose computer later described with respect to FIG. 7. Initially, in step 500 the ray passes through the sector and then traverses a face of the sector upon exit, as shown in step 505. Although not shown, while the ray is passing through the sector, intersect tests are performed to determine what geometric primitives (if any) in the sector the ray will intersect.

Next, in step 510 information associated with the exit face of the sector is used to determine the course of the ray. For example, the information may be used to determine a next sector through which the ray will traverse. If the exit face of the sector is a multi-sector face, as determined in step 515, then the appropriate node is identified and the ray will follow the path of the node toward its next destination. If the face is not a multi-sector face, then the information from the exit face determines the path of the ray toward its next destination (e.g., a next sector). Note that a multi-sector face is a face of a sector that can lead to more than one sector, as previously described. These faces are associated with nodes that assist in determining the path of the ray after traversing the multi-sector face.

Advantageously, the non tree-based three dimensional space partitioning structure is built as a complex three dimensional graph of sectors and nodes. Rays traverse the spatial structure to directly resolve the geometric primitives they intersect. Sectors are regions of space which can take any shape or size, may overlap, and to minimize traversal cost, empty space is typically contained in large sectors while many smaller sectors contain the geometric primitives. In one embodiment sectors are axis-aligned hexahedral spatial regions. Each sector contains information associated with each of its surfaces. The information provides details about the direction of travel of a ray that is traversing the planar face, which may lead either to another sector or a node.

In one embodiment, several mechanisms are used to avoid resolving the origins of rays within graphs, which is a relatively expensive operation that can be avoided using the systems and methods disclosed herein. First, if appropriate, multiple rays can be traced from the same resolved sector of origin. Second, for rays that do not share a common origin, displacements from existing ray sources can be used, essentially traversing the graph from a given root sector up to the point of origin of the ray before initiating the ray tracing from this point and intersecting the geometry of the graph. Third, the sectors which contain the intersection points of previous rays can be stored in memory and recalled later for use with other rays. Advantageously, this provides for very efficient bouncing of rays used for global illumination and other applications.

Note that when a ray traverses a sector that contains geometry, it is sliced into segments given by the face of a sector. The ray-triangle intersection test is particularly well suited for use with the graph architecture described herein and is highly efficient when dealing with short ray segments. Unlike most ray-triangle intersection algorithms, triangles are not internally stored as vertices but rather as a pre-computed form for these high-performance segment intersection tests.

FIG. 7 is a block diagram illustrating an example computer system 550 that may be used in connection with various embodiments described herein. For example, the computer system 550 may be used in conjunction with a computation server providing ray tracing services. However, other computer systems and/or architectures may be used, as will be understood by those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A method for tracing rays through a computer generated three dimensional scene having a plurality of geometric primitives, comprising:
initializing a data structure configured to store information related to the three dimensional scene;
identifying a plurality of geometric primitives within the three dimensional scene;
defining one or more three dimensional sectors, wherein each of the one or more three dimensional sectors contains at least one of the identified plurality of geometric primitives;
storing information related to each of the one or more three dimensional sectors in the data structure;
identifying one or more regions of contiguous empty space within the three dimensional scene;
defining one or more three dimensional space sectors, wherein each of the one or more three dimensional space sectors contains an identified region of contiguous empty space;
storing information related to each of the one or more three dimensional space sectors in the data structure;
identifying a sector having a face that is contiguous with two or more neighboring sectors;
defining a first node in association with a first portion of the face of the identified sector, the first node comprising an identifier that identifies a first neighboring sector;
defining a second node in association with a second portion of the face of the identified sector, wherein the first portion of the face and the second portion of the face do not overlap, the second node comprising an identifier that identifies a second neighboring sector;
storing information related to the first node and the second node in the data structure in association with the identified sector face.

2. The method of claim 1, wherein the surface of each sector consists of a plurality of planar faces.

3. The method of claim 2, wherein the shape each sector is a hexahedron.

4. The method of claim 3, wherein each sector is axis-aligned with each other sector.

5. The method of claim 1, further comprising minimizing the size of each sector containing a geometric primitive.

6. The method of claim 1, further comprising maximizing the size of each sector containing contiguous empty space.

7. A method for tracing a ray through a computer generated three dimensional scene having a plurality of geometric primitives, comprising:
identifying a ray within the three dimensional scene;
determining a first sector traversed by the ray;
determining a first face of the first sector traversed by the ray;
analyzing information associated with the first face to determine a path for the ray within the sector;
calculating the result of an intersect test for the determined path of the ray to identify each geometric primitive within the first sector that the ray will intersect;
determining a second face of the first sector traversed by the ray;
analyzing information associated with the second face to determine a path for the ray outside of the sector; and
determining a second sector the traversed by the ray based on the determined path of the ray.

8. The method of claim 7, wherein analyzing information associated with the second face comprises analyzing two or more nodes, wherein each node is associated with a unique region of the second face.

9. The method of claim 8, wherein the information associated with each node comprises an identifier that identifies a unique neighboring sector.

10. The method of claim 9, further comprising selecting one of the two or more nodes based on the region of the second face through which the ray will travel.

11. The method of claim 10, further comprising tracing the ray to a face of the unique neighboring sector identified by the selected node.
